(19) United States
(12) Patent Application Publication
(10) Pub. No.: US 2024/0421600 A1
(43) Pub. Date: Dec. 19, 2024

(54) DISTRIBUTED POWER SYSTEM FOR MANAGEMENT AND CONTROL

(71) Applicant: REON Technology, Inc., Chelmsford, MA (US)

(72) Inventors: Xuanhang Zhang, Austin, TX (US); Tiegeng Ren, Westford, MA (US)

(73) Assignee: REON Technology, Inc., Chelmsford, MA (US)

(21) Appl. No.: 18/814,501

(22) Filed: Aug. 24, 2024

Related U.S. Application Data
(63) Continuation-in-part of application No. 18/385,439, filed on Oct. 31, 2023.
(63) Continuation-in-part of application No. 18/137,471, filed on Apr. 21, 2023.
(63) Continuation-in-part of application No. 18/115,811, filed on Mar. 1, 2023.
(60) Provisional application No. 63/536,514, filed on Sep. 5, 2023.
(60) Provisional application No. 63/534,791, filed on Aug. 25, 2023.
(60) Provisional application No. 63/422,464, filed on Nov. 4, 2022.
(60) Provisional application No. 63/334,160, filed on Apr. 24, 2022.
(60) Provisional application No. 63/333,708, filed on Apr. 22, 2022.
(60) Provisional application No. 63/334,160, filed on Apr. 24, 2022.
(60) Provisional application No. 63/334,106, filed on Apr. 23, 2022.
(60) Provisional application No. 63/333,708, filed on Apr. 22, 2022.
(60) Provisional application No. 63/315,550, filed on Mar. 2, 2022.
(60) Provisional application No. 63/666,285, filed on Jul. 1, 2024.

(51) Int. Cl. H02J 3/38; H02J 3/32; H02J 13/00

(52) U.S. Cl. CPC H02J 3/381; H02J 3/32; H02J 13/00002; H02J 13/0004; H02J 2203/10; H02J 2300/24

(57) ABSTRACT

Techniques for managing direct current (DC) power sources are disclosed. A plurality of DC power sources is accessed. The DC power sources are configured using a series connection. The series connection is bypassed using a distributed controller-switch. Each distributed controller-switch is monitored using a system controller. The distributed controller-switch includes a bypass switch, a series switch, one or more sensors, and a communications module coupled to the system controller. The bypass switch and the series switch comprise a mutually exclusive switching connection. The mutually exclusive switching connection enables dead-zone control. An optimal DC power source configuration is computed, based on the monitoring. The DC power sources are reconfigured, based on the computing. The reconfiguring enables a level voltage and/or a level current at output terminals of the series connection. The reconfiguring enables hot swapping of one or more of the DC power sources.

### RELATED APPLICATIONS

This application claims the benefit of U.S. provisional patent applications “Distributed Power System For Management And Control” Ser. No. 63/534,791, filed Aug. 25, 2023, “Battery Management System With Low Latency” Ser. No. 63/536,514, filed Sep. 5, 2023, and “Battery Management System With In Situ Cell Rejuvenation” Ser. No. 63/666,285, filed Jul. 1, 2024.

This application is also a continuation-in-part of U.S. patent application “Software-Defined Energy Storage System Interface” Ser. No. 18/115,811, filed Mar. 1, 2023, which claims the benefit of U.S. provisional patent applications “Software-Defined Energy Storage System Interface” Ser. No. 63/334,106, filed Apr. 23, 2022, “Battery System Management Using Cell State” Ser. No. 63/333,708, filed Apr. 22, 2022, “Battery Performance Tracking Across Battery Cells” Ser. No. 63/334,160, filed Apr. 24, 2022, and “Dynamic Control Of A Disparate Battery System” Ser. No. 63/315,550, filed Mar. 2, 2022.

This application is also a continuation-in-part of U.S. patent application “Battery Performance Tracking Across Battery Cells” Ser. No. 18/137,471 filed Apr. 21, 2023, which claims the benefit of U.S. provisional patent applications “Battery System Management Using Cell State” Ser. No. 63/333,708, filed Apr. 22, 2022 and “Battery Performance Tracking Across Battery Cells” Ser. No. 63/334,160, filed Apr. 24, 2022.

This application is also a continuation-in-part of U.S. patent application “Battery Management System With Controlled Replacement” Ser. No. 18/385,439, filed Oct. 31, 2023, which claims the benefit of U.S. provisional patent applications “Battery Management System With Controlled Replacement” Ser. No. 63/422,464, filed Nov. 4, 2022, “Distributed Power System For Management And Control” Ser. No. 63/534,791, filed Aug. 25, 2023, and “Battery Management System With Low Latency” Ser. No. 63/536,514, filed Sep. 5, 2023.

Each of the foregoing applications is hereby incorporated by reference in its entirety.

### FIELD OF ART

This application relates generally to direct current (DC) power management and more particularly to a distributed power system for management and control.

### BACKGROUND

Scientific studies of human-caused climate change indicate that substantial environmental impacts are already occurring. Extreme heat, drought, excessive precipitation, and wildfires are all considered to be direct results of climate change. These and other alarming events are motivating transitions in corporate business practices and consumer purchasing choices. These environmental changes are being experienced globally, causing corporations and individuals to adopt the guiding principles of “reduce, reuse, and recycle”, known collectively as the three Rs. These changes in corporate and individual behavior are at times being suggested though gentle means such as education and encouragement through public service announcements, advertisements, and educational programs. Other changes are being mandated at local, state, and national levels. More than half of US states require businesses and private citizens to recycle at least one material. The recycling is accomplished by separating the recyclable material from other waste that goes to a landfill. Some states go further, requiring more materials to be recycled and mandating the separation of food waste for composting. The latter objective is to reduce methane production in landfills.

Perhaps no industry has received more pressure to reduce carbon emissions than the vehicle sector. While improving gas mileage has traditionally been a focus of the industry, recent technological advancements have made possible hybrid, hybrid plug-in, and fully electric vehicles which significantly reduce overall carbon emissions. Many of these vehicles require electrical recharging to restore battery charge. Thus, demand for electrical power is rapidly increasing, causing great concern about existing energy generation facilities, existing electrical grid infrastructure, and plans for future energy generation and distribution. Further, the increase in electrically powered vehicle usage has caused an increase in used batteries which contain hazardous materials. Power generation and electronic devices of all types have the unintended consequence of producing used batteries, adding to the problem of environmental pollution.

The technological improvements in storage devices such as rechargeable batteries have greatly improved the consumer experience (UX) with and practicality of portable, personal electronic devices. The proliferation of rechargeable batteries has also accelerated advancements in remote computing. The improved batteries have created entirely new markets, replaced old markets, and generated new product categories. Desktop computers which once ruled the computer market have been largely supplanted by laptop computers and handheld devices that enhance the computing experience for individuals. Now, computers can be used for work or play practically anywhere: in airports, on planes, in coffee shops, or while sitting on the beach in Maui. Consumer purchase behavior is now driven by expanded device capabilities facilitated by the improved rechargeable batteries. Purchase decisions are not only influenced by device performance metrics, but also by factors such as battery life. Beyond personal electronic devices, batteries play critical roles in everyday life. At home, disposable batteries are found in flashlights, clocks, pet trainers, remote controls, etc. Batteries also play safety roles in smoke detectors and in home medical equipment. Further, all public buildings in the United States are legally required to have lighted exit signs, highlighting the path to safety in case of a fire or emergency. Batteries ensure that these signs glow brightly, even if the building's power fails. Likewise, battery-powered safety equipment can be found on boats, airplanes, and other vehicles.

### SUMMARY

The demand around the globe for energy sources that are ecologically and environmentally favorable is driving the development of alternative energy sources. The “eco” or “green” sources are largely based on renewable energy sources. Such energy sources include solar and wind. Other energy sources include geothermal sources and wave action sources. Further energy sources are resurrecting old technologies such as tidal mills, where ocean tides are used to capture water at high tide which can then be used to produce energy when the tide is out. One of the major challenges of these alternative or green energy sources is that the sources do not produce sufficient energy 24 hours a day. While solar panels produce power on a sunny day, their power outputs are reduced on cloudy days or minuscule at night. Windmills only produce energy from wind when the wind is blowing, and power produced by geothermal technologies is greatest at geographic locations where geothermal energy is readily available. Other energy sources such as burning of biomass or biogas have also been used, but concern remains that burning biomass and biogas produces carbon dioxide, ash, and other undesirable byproducts. Thus, techniques for storage of energy produced by renewable sources are garnering great interest globally.

Techniques for managing direct current (DC) power sources are disclosed. The DC power sources are configured using a series connection. The series connection is bypassed using a distributed controller-switch. Each distributed controller-switch is monitored using a system controller. The distributed controller-switch includes a bypass switch, a series switch, one or more sensors, and a communications module coupled to the system controller. The bypass switch and the series switch comprise a mutually exclusive switching connection. The mutually exclusive switching connection enables dead-zone control. An optimal DC power source configuration is computed, based on the monitoring. The DC power sources are reconfigured, based on the computing. The reconfiguring enables a level voltage and/or a level current at output terminals of the series connection. The reconfiguring enables hot swapping of one or more of the DC power sources.

A processor-implemented method for direct current (DC) power management is disclosed comprising: accessing a plurality of DC power sources, wherein the DC power sources are configured using a series connection; bypassing the series connection, wherein the bypassing occurs at each of the DC power sources within the plurality of DC power sources, and wherein the bypassing is performed by a distributed controller-switch; monitoring each distributed controller-switch using a system controller; computing an optimal DC power source configuration, based on the monitoring; and reconfiguring the plurality of DC power sources, based on the computing.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a distributed power system for management and control.

FIG. 2 is a flow diagram for bypassing a series connection.

FIG. 3 is a block diagram for distributed control and management of photovoltaic (PV) panels.

FIG. 4 is a block diagram detail of a distributed controller.

FIG. 5 is a block diagram for switching connections of photovoltaic panels.

FIG. 6 is a block diagram for switching connections of photovoltaic panels and batteries in one string.

FIG. 7 is a block diagram for a distributed control and management system for direct current (DC) systems.

FIG. 8 is a system diagram for a distributed power system for management and control.

### DETAILED DESCRIPTION

A DC power management and control system can provide primary, supplemental, or backup energy to a wide range of energy consumers. The power system can manage and control energy generation and, in embodiments, energy storage, where the energy management and storage are accomplished using new, recycled, reclaimed, or repurposed energy generation and energy storage elements. New energy management and energy storage elements can also be used. Common energy consumers include various sizes of public and private enterprises and individuals. The DC power management system can use a system controller to control an energy storage system. The system controller can be in communication with distributed controller-switches which are coupled to each of the DC power sources. The power management system can generate DC power, store DC power, or in preferred embodiments, can both generate and store DC power. The energy generation portion of the power system can be assembled from photovoltaic (PV) solar panels, where the PV panels can include recycled or repurposed PV panels. The energy storage portion of the power system can be assembled from battery units, where the battery units comprise new battery units and/or recycled battery units.

The system controller can be used to control, define, and configure the energy generation system and the storage system using electronically controlled switches. These switches are used to configure the energy system as needed to meet energy load demands. The configuration can enable or disable energy generation and energy storage devices, can bypass the devices, and so on. The system controller can further process PV panels and battery unit performance characteristics. The performance characteristics can be provided by one or more sensors associated with a local, distributed controller-switch corresponding to each DC power source and each DC storage unit. The PV panel and battery unit performance characteristics can be communicated in real time between the one or more distributed controller-switches and the system controller using a provided signal communications module. The system controller can accomplish real-time power capability adjustment of the energy generation and energy storage systems by performing in situ PV panel and battery unit reconfiguration. The in situ reconfiguration can include adding panels and/or battery units to provide additional energy, disconnecting or bypassing unneeded PV panels and battery units, and so on. The in situ reconfiguration can include rewiring the existing wiring without changing the panels and/or battery units. The real-time power capability adjustment provides matching between DC power system performance and distributed power system management and control load requirements.

A DC power system can be comprised of photovoltaic panels and batteries of various types. The panel types can include various sizes, voltage and current ratings, sources, manufacturers, and so on. The battery types can be based on a variety of rechargeable battery technologies, such as those batteries widely used in consumer, medical, and other products. For example, every portable electronic device such as a smartphone, laptop computer, tablet computer, smartwatch, and so on contains a rechargeable battery. Further, the rise in popularity of hybrid, hybrid plug-in, and fully electric vehicles has greatly expanded reliance on, and user confidence in, larger rechargeable batteries. Some uses for rechargeable batteries are found behind the scenes. For example, renewable energy storage systems use large batteries to provide power to power grids when renewable sources are offline. The power that is stored in the renewable energy storage systems can be generated by the variety of PV panels. Whether obvious or hidden, all rechargeable batteries age over time, primarily due to charge/discharge cycling. As a result, the rechargeable battery systems become unable to meet the technical specifications provided by the manufacturer, and the batteries require replacement. New batteries must be installed, and the replaced batteries pose significant problems for the environment due to the metals and chemicals that comprise the batteries. For the new batteries, additional lithium must be mined, consuming massive amounts of water, harming soil, and causing air contamination. The batteries that have been removed from equipment can start fires if not stored properly. In many cases, however, the replaced batteries are still capable of storing and delivering energy, if the batteries can be confirmed safe, and can then be redeployed in new applications.

The disclosed method for a direct current (DC) power management system includes techniques for effective generation, control, and delivery of power as needed to power loads. The DC power management system controls a plurality of DC power sources. The DC power sources include photovoltaic (PV) solar cells. In embodiments, the DC power sources can further include battery units. The DC power system can include and reuse existing PV panels and rechargeable batteries that have been removed from their original service. The DC power system can be retrofitted into an existing solar farm to enhance functionality and improve performance. The batteries can be recovered and repurposed from a variety of products such as electric vehicles. The reuse of PV panels and of the recovered batteries directly reduces electronic waste. For example, PV panels with degraded performance can be removed from service and can be provided a “second life”. Similarly, the rechargeable batteries can be recovered. The panels and the batteries can be scanned to collect performance information and to determine usability and capacity. The performance information can be collected initially and over time to be used for regulatory purposes, such as reporting, compliance, carbon footprint reduction calculations, and so on. The carbon footprint-related performance information can be used for tracking full lifecycle carbon footprint performance for batteries and other DC power sources.

New power applications can use the recovered PV panels and batteries by adding distributed electronic controller-switches to select or deselect PV panels and battery units that make up the DC power system. The PV panels can be selected when sufficient light impinges on the panels to generate DC power to power various loads. The battery units can be selected when in use by the DC power system or for recharging, or deselected when the battery unit is unneeded or inadequate for a particular battery configuration. Scanners or sensors can also be added to the PV panels and battery cells to monitor panel and cell parameters such as age, voltage, and cell voltage, numbers and cycles of charge/discharge current capabilities for the panels, battery unit “health”, and so on. Frequent monitoring of the DC power sources can detect problems with one or more panels or battery units within the DC power system, such as overheating, a low impedance such as a short circuit, etc. Thus, problematic PV panels or battery units can be quickly removed from service. Batteries can be safely discharged, thereby reducing or eliminating the risk of fire or explosion. The removed PV panels and battery units can be replaced with units that are substantially similar to the removed units or substantially different from the removed cells. PV panels can be removed temporarily due to deleterious temporary environmental conditions, such as being in the shade, accumulating dirt, coverage by leaves or other foreign material, snow or ice covering, etc.

The PV panels and the batteries are configured into one or more series connections. The series connections can further be connected into series connections, parallel connections, or serial-parallel connections. The PV panels and batteries are controlled using electronically controlled switches. The PV panels can be selected to meet a load voltage or load current requirement. The PV panels can be assembled into a DC power system comprising substantially similar or substantially dissimilar panels. The battery units can be assembled into a disparate battery system portion of the DC power system, comprising a plurality of battery units. The battery units can be selected for use or recharging by the PV panels. The batteries can further be bypassed when unneeded or being prepared for battery unit replacement.

The batteries within the DC power system can include rechargeable batteries such as lithium-ion batteries that have been removed from vehicles, energy storage devices, personal electronic devices, and so on. These batteries can be considered used, “previously used”, preowned, “second life”, second hand, or can be described with some other terminology denoting a second usage. The batteries can be a mixture of “previously used” batteries and new batteries. Battery unit characteristics can be collected by local controllers associated with each of the battery units. The local, distributed controller-switches can collect sensor data from sensors associated with the PV panels and the battery units. The PV panel and battery unit characteristics can be used to generate PV panels and battery unit profiles, where the profiles can be used to store information about the PV panels and the battery units. Information obtained from the sensors can include temperature, current, voltage, impedance, number of cycles, and so on. Communication between the system controller and the local distributed controller-switches associated with each PV panel and each battery unit can be accomplished using a communications module within the distributed controller-switches. The communications module can support communications based on an Industrial Internet of Things (IIoT) capability.

The system controller can handle queries such as DC power system capability, energy availability for output, and so on. Further queries handled by the system controller can include a power request with parameters which can include voltage requirements, current requirements, power requirements, changing the direction of current flow to charge or discharge the battery units using the PV panels, changing the voltage output of the system; balancing energy generation and storage between multiple DC power systems, responding to a power grid demand, and so on. The DC power system can be reconfigured in situ using the system controller. The in situ PV panel and battery unit reconfiguration can enable real-time power capability adjustment for the plurality of PV panels and battery units. The power capability adjustments can include energy storage capacity, energy delivery capacity etc. The reconfiguration can further enable removal and replacement of one or more PV panels or battery units. The PV panels or battery unit replacement can be initiated by a press of a button associated with the PV panel or battery unit to be replaced. The removed PV panels or battery units can be replaced with a substantially similar PV panel or battery unit, or a substantially different PV panel or battery unit.

Disclosed techniques include a distributed power system for management and control. The distributed power system is based on DC power sources, which can include photovoltaic (PV) panels, batteries, capacitors, and so on. A plurality of DC power sources is accessed, wherein the DC power sources are configured using a series connection. The DC power sources can include new, repurposed, recycled, recovered, and other DC power sources. The DC power sources can include substantially similar or substantially different power sources. The DC power sources can include heterogeneous power sources. The series connection can be bypassed. The bypassing occurs at each of the DC power sources within the plurality of DC power sources. The bypassing can be associated with one or more power sources. The bypassing is performed by a distributed controller-switch. A distributed controller-switch can be coupled to each DC power source. The distributed controller-switch can include a bypass switch, a series switch or series switch pair, one or more sensors, and a communications module coupled to the system controller. Each distributed controller-switch is monitored using a system controller. The monitoring the distributed controller-switch can include collecting, by the system controller, sensor data from the sensors associated with the distributed controller-switches. An optimal DC power source configuration is computed, based on the monitoring. The computing can be accomplished by a personal electronic device, a computer, a server, and so on. The computing can be accomplished by a purpose-built computing device for distributed power system management and control. The plurality of DC power sources is reconfigured, based on the computing. The reconfiguring can include adding or removing DC power sources, adding or removing series connections of DC power sources, bypassing power sources, etc.

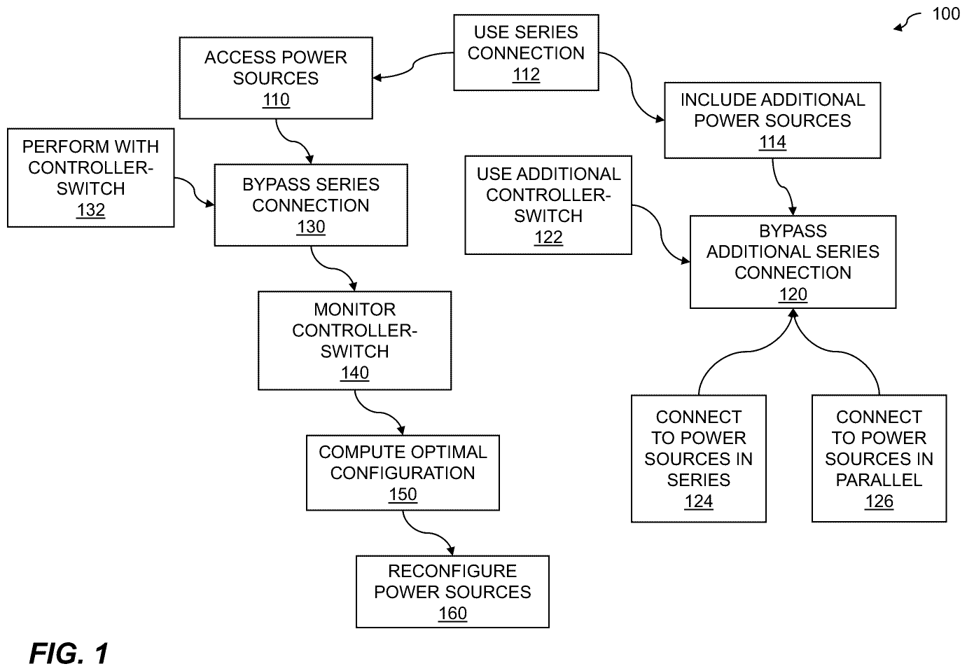

FIG. 1 is a flow diagram for a distributed power system for management and control. A DC power system comprised of any combination of new or used photovoltaic (PV) panels can be configured by a system controller using electronically controlled switches. The DC power system can further be comprised of new or used battery units configured by the system controller using switches. The switches can configure DC power sources comprising the PV panels and battery units into one or more series connections. The electronic switches can also connect the series connections in parallel to comprise the DC power system. The electronically controlled switches can further connect or bypass each DC power source. The connecting can be accomplished using a series switch (or switches) that connect or disconnect DC power source terminals to a power bus. The bypassing can be accomplished using a shunt, or bypass, switch to bypass the DC power source. The connecting or bypassing can be based on a power system configuration, where the configuration includes voltage and current levels, run times, etc. PV panel and battery unit performance information can be obtained on DC power sources within the DC power system, including DC power source profile, safety information, temperature, current, voltage, impedance, and so on. Further profile information associated with the battery units can include charge/discharge cycle count, and so on. Information on the DC power system can be provided by distributed controller-switches coupled to each DC power source. The distributed controller-switches can use a communications module within each distributed controller-switch to provide the information to the system controller. The system controller can reconfigure the DC power system in situ to match management and control system load requirements. The DC power system reconfiguration can be based on removing, replacing, or adding DC power sources, power request parameters, and so on.

The flow 100 includes accessing 110 a plurality of DC power sources. The plurality of DC power sources can include photovoltaic panels, batteries, capacitors, and other components for storing electrical energy. In embodiments, the plurality of DC power sources includes a solar panel array. In the flow 100, the DC power sources are configured using a series connection 112. The DC power sources can be configured in more than one series connection. In a usage example, a plurality of PV panels can be configured in a series connection and a plurality of batteries can be configured in an additional series connection. The series connection and the additional series connection can be configured in a series connection, in a parallel connection, in a series parallel connection, and so on. The configuring the DC power sources using series connections can be accomplished with electronically controlled switches. The configuring the DC power sources in series can attain a desired output voltage. The series connections of DC power sources can further be connected in parallel using electronically controlled switches. The electronically controlled switches can include solid-state switches. The connecting the DC power sources in series can attain a desired output current for the DC power system, a desired run time for the system, a desired level of reliability, and so on. Each DC power source of the plurality of DC power sources can be connected to a power bus through a series switch or series switch pair. The series switch can connect terminals of PV panels to the power bus. The series switch can connect each anode power connection of each battery unit and each cathode power connection of each battery unit to the power bus. The battery units can be formed from other battery units, where the battery units can include rechargeable batteries such as lithium-ion batteries that have been removed from vehicles, energy storage devices, personal electronic devices, and so on. These batteries can be considered used, “previously used”, preowned, “second life”, recovered, etc., in addition to new or unused batteries.

In embodiments, the plurality of PV panels can include cadmium-telluride panels, thin film, amorphous silicon, monocrystalline silicon, copper indium gallium selenide, and other PV panel techniques. In other embodiments, the plurality of battery units includes lithium-ion battery units. Other types of rechargeable cells can be included, such as sealed lead-acid (SLA), nickel-cadmium (NiCd), nickel-metal hydride (NiMH), lithium-polymer (LiPo), lithium-iron-phosphate (LiFePO4), solid-state, sodium ion, zinc based, etc. The PV panels and the battery units can include profiles. The PV panel and battery unit profiles can include a variety of information associated with a PV panels battery unit including information on aging, brand, or specification. In embodiments, the profiles include manufacturing date; batch number; serial number; in-service date; removed-from-service date; notations about observed wear, cracks, or damage; etc. The profiles can be uploaded by a user, downloaded from a library or repository, and so on. The profiles can be determined while the DC power system is in use.

The flow 100 further includes using additional DC power sources 114 in the series connection. The additional power sources can include PV panels, batteries, capacitors, and so on. The additional power sources can be colocated with the power sources, can be located adjacent to the power sources, etc. In embodiments, the additional DC power sources can include one or more battery units. Discussed previously, the battery units can include lithium-ion or other rechargeable battery technologies. The battery units can be configured in series connections, parallel connections, series-parallel connections, and the like. The flow 100 further includes using additional DC power sources in an additional series connection 112. In embodiments, the one or more battery units can function as an energy source. The battery units can be used to supplement an energy source based on the PV panels, to be used in place of the PV panels during low light conditions, etc. In other embodiments, the one or more battery units can function as an energy load. The batteries can be charged by the PV panels when excess DC power is available due to low power load. The batteries can be charged by the PV panels when the batteries require recharging.

The flow 100 further includes bypassing the additional series connection 120 at each of the additional DC power sources such as the battery units. The bypassing can be performed in order to remove or replace a DC power source, to maintain a DC power source, to balance overall voltage and/or current, and so on. Discussed below in detail, in the flow 100, the interrupting is accomplished by an additional distributed controller-switch 122. The additional controller switch can include one or more components that can enable control of the DC power source to which the additional distributed controller switch is coupled. The control can be accomplished by a system controller. In embodiments, each additional distributed controller-switch can be monitored by the system controller. The additional distributed controller-switch comprises a bypass switch, a series switch or switch pair, one or more sensors, and a communications module coupled to the system controller. The controller-switch can be used to bypass the additional series connection. The series switch can be used to enable, disable, or interrupt a battery unit. The sensors can sense various parameters associated with the battery unit such as temperature, voltage, current, resistivity, and the like. The communications module can enable communications between the additional communications-switch and the system controller.

The DC power sources, and the additional DC power sources, can be coupled to a power converter, such as a DC-to-DC converter or a DC-to-AC inverter. The DC power sources, and the additional DC power sources, can be coupled to a DC-to-DC converter, which then feeds an inverter. The inverter can be used to convert or “invert” DC power from the DC power sources to AC power. The AC power to which the DC power is inverted can include AC power at standard voltages and currents, AC power at specialized voltages and currents, and the like. In the flow 100, power from the series connection and power from the additional series connection can both supply a common power conversion device in series 124. The series connection and the additional series connection can be configured in a series connection to attain a desired input voltage or other specified DC power requirements. In the flow 100, power from the series connection and power from the additional series connection can both supply a common power conversion device in parallel 126. The series connection and the additional series connection can be configured in a parallel connection to attain a desired input current.

The flow 100 includes bypassing the series connection 130. The series connection can be bypassed to remove a DC power source, to replace the DC power source, to maintain the DC power source, and so on. The bypassing occurs at each of the DC power sources within the plurality of DC power sources. The bypassing at each of the DC power sources enables the removal, addition, replacement, maintenance, etc. of an individual DC power source without having to disable an entire series connection of DC power sources, shut down an entire DC power system, and the like. In the flow 100, the bypassing is performed by a distributed controller-switch 132. A distributed controller-switch can be coupled to each DC power source. The distributed controller-switch enables monitoring and control of each DC power source individually. Such granular monitoring and control enable the identification of underperforming or failing DC sources, DC sources that require maintenance, DC sources that pose potential fire hazards, etc. In embodiments, the distributed controller-switch comprises a bypass switch, a series switch, one or more sensors, and a communications module coupled to the system controller. The bypass switch and the series switch can include electronically controlled switches. In embodiments, the bypass switch and the series switch comprise insulated-gate bipolar transistor switches. Switches based on other semiconductor technologies can also be used. The sensors can include voltage, current, and temperature sensors; resistivity sensors; damage and/or leakage sensors; etc. The communications module can enable communications between a distributed controller-switch and a system controller. In embodiments, the coupling to the system controller can be performed using wired technology. The wired technology can be based on a variety of wired communications protocols. The wired communications protocols can include USB, RS-232, RS-485, and the like. The communications standards used for coupling the distributed controller-switch to the system controller can further include Ethernet™, Ethernet/IP™, and EtherCAT™; fiber distributed data interface (FDDI), fiber channel, asynchronous transfer mode (ATM), etc. In other embodiments, the coupling to the system controller can be performed using wireless technology. The wireless communication techniques can include, 802.11, Zigbee™, near-field communication (NFC), and so on. The communications standards can further include Industrial Internet of Things (Industrial IoT, IIoT).

Discussed above, the electronically controlled switches within the distributed controller-switch include a bypass switch and a series switch. The bypass switch can be used for bypassing a DC power source, and the series switch can be used to enable or disable the DC power source. In embodiments, the bypass switch and the series switch comprise a mutually exclusive switching connection. In a usage example, the series switch can be closed to enable a particular DC power source to be coupled to the series configuration of DC power sources. The bypass switch associated with the same DC source can remain open. If the bypass switch were to close while the series switch was closed, a short-circuit condition would exist across the terminals of the DC power source. In embodiments, the mutually exclusive switching connection can enable dead-zone control. A dead zone can include an amount of time during which the state of a DC power source can transition between enabled and bypassed. The dead-zone control can be used to prevent damage to the DC power source, damage to the DC power system to which the DC power source is coupled, and so on. In embodiments, the dead-zone control prevents short-circuit current flow. Preventing short-circuit current flow is essential to protecting the DC power source and the DC power system. Preventing short-circuit current flow can reduce the risk of fire or catastrophic failure of a DC power source.

The flow 100 includes monitoring each distributed controller-switch 140 using a system controller. The system controller can include a built-in, purpose-built, or other processing device. The system controller can communicate with the one or more distributed controller-switches coupled to the DC power sources. In embodiments, the one or more sensors within the distributed controller-switch enable the monitoring. The sensors can include voltage, current, resistivity, temperature, leakage, and other sensors. The sensors can provide data associated with the DC power source. The system controller can collect and analyze the sensor data for each sensor within each distributed controller-switch. The flow 100 includes computing an optimal DC power source configuration 150, based on the monitoring. An optimal DC power source configuration can be based on a target voltage or current; average, peak, and standby power requirements; one or more reliability factors; and so on. The computing can be performed using a variety of computing devices. The computing devices can be based on one or more processors. The computing devices can include personal electronic devices such as a smartphone or tablet; a computer such as a laptop or desktop computer; a local, remote, or cloud server; and the like. The computing device can include a purpose-built computing device for monitoring, managing, and controlling a DC power system.

The flow 100 includes reconfiguring 160 the plurality of DC power sources, based on the computing. The reconfiguring the DC power sources can include enabling or disabling power sources; adding or removing power sources; configuring additional power sources using series connections; and so on. The reconfiguring can enable DC power system features based on voltage, current, runtime, reliability, safety factors, and the like. In embodiments, the reconfiguring can enable a level voltage at output terminals of the series connection. The level voltage can include a target value, a tolerance, a threshold, etc. In other embodiments, the reconfiguring enables a level current at output terminals of the series connection. The level current can also include a target value and other requirements. Discussed previously, DC power sources can be added, removed, bypassed, interrupted, and so on. In embodiments, the reconfiguring can enable hot swapping of one or more DC power sources of the plurality of DC power sources. In a usage example, a DC power source such as a PV panel requires maintenance. A second PV panel can be substituted in the series connection of which the first panel was an element. The second panel can support continued operation of the series connection while the first panel is disabled for maintenance. In other embodiments, the computing and the reconfiguring can enable meeting a DC power source reliability metric. The reliability metric can include a safety factor, a runtime parameter, an uptime requirement, a mean time to failure (MTTF) factor, and so on.

The reconfiguration can be based on negotiating subsequent power parameters based on both a set of power request parameters received and information on the DC power system. The negotiating can be accomplished during run time. The negotiating can be based on a target voltage; current; duration; safety factors; a predefined voltage such as 48 volts, 80 volts, 120 volts, 480 volts, 800 volts, 1000 volts, or some other voltage; etc. The negotiating can be in response to changes in an amount of DC power available due to such events as decreasing sunlight impinging on the PV panels, battery unit voltages as the battery units discharge, and so on. In embodiments, in situ DC power source reconfiguration enables real-time power capability adjustment for the plurality of DC power sources. The real-time capability can be based on an amount of stored energy provided by the PV panels, an amount of remaining charge within the DC power system, an amount of energy available for recharging battery units or changing loads, etc. In embodiments, the real-time power capability adjustment can provide matching between DC power system performance and DC power management system load requirements. The real-time power capability adjustment can be used to prolong energy delivery run time; to avoid discharging battery units too deeply; to prevent battery units from overheating; and to respond quickly to detect overheated battery units, precipitous battery unit impedance drops, and other dangerous battery conditions which could result in battery unit damage or combustion.

The DC sources described above can be used to provide DC power to one or more DC loads. In embodiments, the DC power sources are used to power an inverter. The inverter “inverts” the DC power to produce AC power. The AC power can be based on a voltage such as a standard voltage, a standard frequency, and so on. In a usage example, the inverter can convert DC power from the DC power sources to 120V 60 Hz AC power. The AC power output by the inverter can be used for a variety of purposes. In embodiments, the inverter can be used to supply alternating current (AC) power to an AC power grid. The AC power grid can include a microgrid; a local, state, regional, or national grid; and so on. The providing AC power to the AC power grid can enable “reverse metering”. In other embodiments, the inverter can be used to supply alternating current (AC) power to an AC load. The AC load can include various types of electrical equipment, appliances, and so on. The AC load can include heating, cooling, and air conditioning (HVAC) loads. In further embodiments, the inverter can be used to supply alternating current (AC) power to an energy storage system. The energy system can convert the AC power back to DC power for storage in one or more DC power storage devices. The DC power storage devices can include batteries, capacitors, and so on. The DC power storage devices and/or DC generation devices can be used as sources to provide DC power to a DC-to-DC converter or directly to DC loads.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

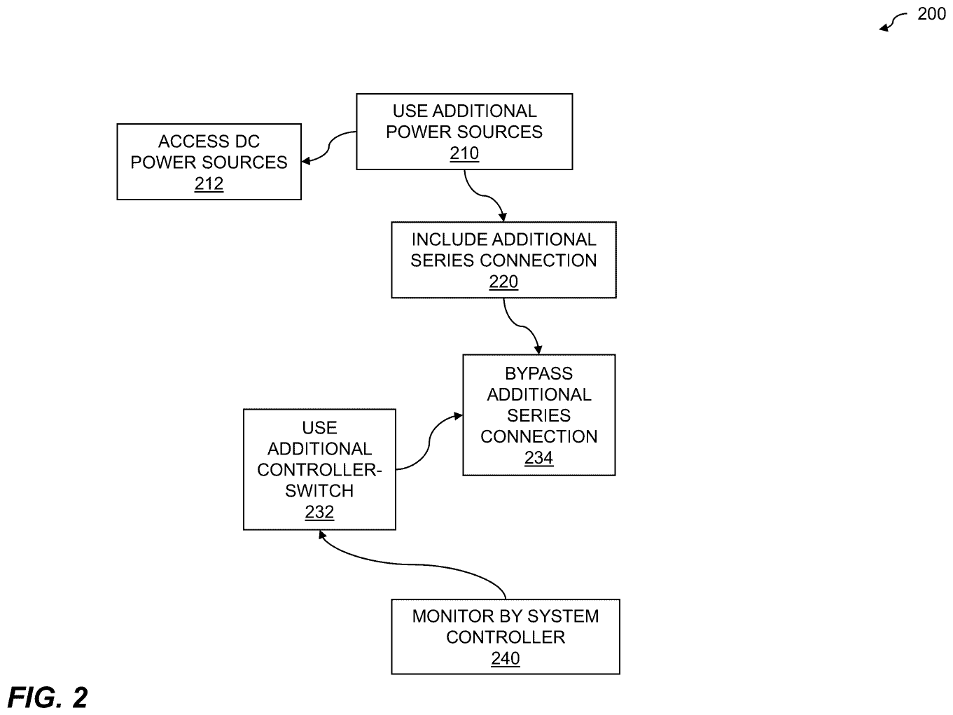

FIG. 2 is a flow diagram for bypassing a series connection. A DC power system can be formed from DC power sources. The DC power sources can include photovoltaic (PV) panels, where the PV panels can include substantially similar PV panels, substantially dissimilar PV panels, and so on. The DC power sources can be configured using a series connection in order to meet one or more DC power system requirements. The DC power system requirements can include a voltage and/or a current, system reliability parameters, and the like. One or more of the DC power sources can be bypassed. The bypassing of a DC power source can be accomplished using a switch and a switch pair. The bypassing of a DC power source can enable DC power source replacement due to DC power source failure; diminished generation capabilities such as PV panel degradation, elevated temperature, or reduced PV panel impedance; and so on. Bypassing a series connection is enabled by a distributed power system for management and control. A plurality of DC power sources is accessed, wherein the DC power sources are configured using a series connection. The series connection is bypassed, wherein the bypassing occurs at each of the DC power sources within the plurality of DC power sources, and wherein the bypassing is performed by a distributed controller-switch. Each distributed controller-switch is monitored using a system controller. An optimal DC power source configuration is computed, based on the monitoring. The plurality of DC power sources is reconfigured, based on the computing.

The flow 200 includes using additional DC power sources 210. The additional sources are included in a series connection of DC power sources. The series connection of DC power sources can include photovoltaic (PV) panels in the series connection. Discussed previously, accessing a plurality of DC power sources can include accessing one or more photovoltaic (PV) panels. In the flow 200, the additional DC power sources to be included in the series connection can be accessed 212. In embodiments, the additional DC power sources can include one or more battery units. The additional DC power sources can also include capacitors such as supercapacitors. In embodiments, the one or more battery units, one or more capacitors, etc. can function as an energy source. The battery units can supplement power provided by the PV panels. In other embodiments, the one or more battery units can function as an energy load. That is, the PV panels can charge the batteries. The batteries associated with the additional DC power sources can include various types of batteries such as rechargeable batteries based on different battery technologies. The batteries can be controlled at a battery cell or battery unit level.

Rechargeable batteries, such as lithium-ion batteries that have been removed from vehicles, energy storage devices, personal electronic devices, and so on, can be reused for other applications. These second use batteries can be fully capable of functioning in certain capacities and usages. While the batteries may no longer meet their original manufacturer specifications with respect to energy storage, leakage, and so on, the batteries can still store and provide energy for other applications. In order to use such “second life” batteries, the batteries can be disassembled down to their battery cells. The battery cells can be reassembled into battery units. Distributed controller-switches can be coupled to the battery units. The distributed controller-switches can include a bypass switch, a series switch, one or more scanners or sensors, and a communications module. The distributed controller-switches can be coupled to a system controller. The switches can be used to couple, decouple, and bypass the battery units, while the sensors can be used to monitor battery performance characteristics such as temperature, current, voltage, or impedance data. The switches, which are based on high-speed switching devices, and the scanners, which can include voltage, current, temperature, and impedance sensors, can be controlled in order to operate the battery units and battery systems formed from the battery units at their most efficient and safest levels. The safe battery levels can be monitored by a failsafe system that monitors safe battery levels and selectively disconnects battery units from the battery system before a battery unit failure. The battery units and systems can be monitored frequently to quickly respond to any detected problems. The monitoring and response enable dynamic control.

The flow 200 includes using additional DC power sources in an additional series connection 220. The additional series connection can be connected in series with the series connection described above. The additional series connection can be coupled in parallel with the series connection. The additional series connection can be used in place of the series connection formed using a plurality of PV panels. Such usage flexibility of the series connection and the additional series connection enables a DC power system to operate for longer periods of time, during low light periods when the PV panels are producing little or no DC power, and so on. In embodiments, the PV panels can be used to recharge the batteries. In a usage example, a series connection of PV panels and an additional series connection of battery units are configured in parallel. The PV panels can provide DC power while the panels are exposed to light. While the DC power produced by the panels exceeds load requirements, DC power can be shunted to the batteries to charge the batteries. The batteries can be used to provide supplemental power when power produced by the PV panels is insufficient to meet power load requirements. Further, the batteries can provide power in place of the PV panels when power output from the panels is low during low light conditions.

Recall that a system controller can control the DC power sources in the series connection of DC power sources by manipulating the DC power sources. Further, the system controller can control the battery units. The flow 200 further includes bypassing the additional series connection 234 at each of the additional DC power sources. The interrupting the connection at each DC power source can include disconnecting a power source. The interrupting or disconnecting a power source can be performed in order to maintain a power source, to remove the power source, to replace the power source, to manage and/or balance the overall system, etc. The disconnecting the power source can be accomplished using a pair of switches: a bypass switch and a series switch. In the flow 200, the bypassing is accomplished by an additional distributed controller-switch 232. The additional distributed controller-switch can include a bypass switch, a series switch or switch pair which can be used for the interrupting, one or more sensors, and a communications module coupled to the system controller. The bypassing can be accomplished using the switch associated with the distributed controller-switch coupled to a battery cell, battery units, etc. The switches associated with the distributed controller-switch can be configured such that the bypass switch does not cause a short circuit across the terminals of the battery. The switches can further be configured such that the series switch does not break the series connection of the plurality of DC power sources comprising batteries. The switches can include solid-state switches that can be controlled by the system controller. In embodiments, the bypass switch and the series switch can include insulated-gate bipolar transistor switches. The controlling of the switches in the distributed controller-switches can be based on computing an optimal DC power source configuration. The computing can be based on monitoring the one or more sensors associated with the distributed controller-switches. In the flow 200, each additional distributed controller-switch can be monitored and/or controlled by the system controller 240. By monitoring each additional distributed controller-switch and by controlling each distributed controller-switch, the system controller can optimize additional DC power sources. By optimizing the additional DC power sources, various power system criteria can be met. The power system criteria can include one or more of a voltage, a current, a reliability factor, a physical size, and so on.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

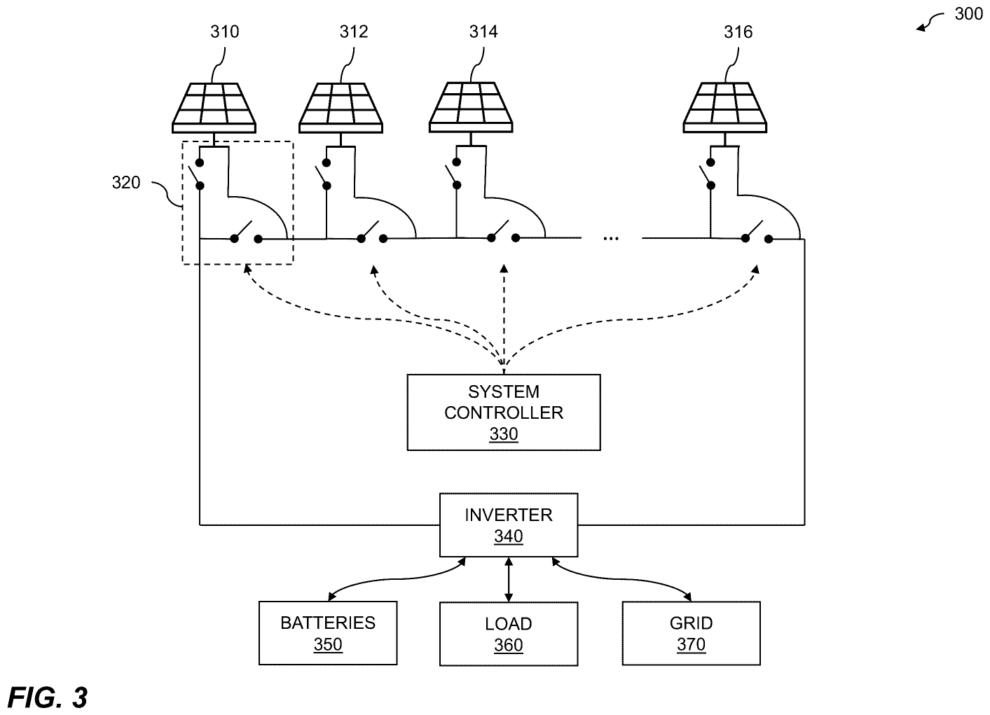

FIG. 3 is a block diagram for distributed control and management of photovoltaic (PV) panels. The control and management of the PV panels can be accomplished using a system controller and a plurality of distributed controller-switches. Each distributed controller-switch can be coupled to a DC power source such as a PV panel. The distributed controller-switch at each PV panel can enable and disable the PV panel by bypassing the panel, enabling the panel, and so on. The control of the PV panel can be based on obtaining sensor data from one or more sensors associated with the distributed controller-switch. The sensors can monitor the operation of the panel, determine whether the panel is operating properly, determine whether the panel requires maintenance or replacement, etc. The distributed control and management of PV panels is enabled by a distributed power system for management and control. A plurality of DC power sources is accessed, wherein the DC power sources are configured using a series connection. The series connection is bypassed, wherein the bypassing occurs at each of the DC power sources within the plurality of DC power sources, and wherein the bypassing is performed by a distributed controller-switch. Each distributed controller-switch is monitored using a system controller. An optimal DC power source configuration is computed, based on the monitoring. The plurality of DC power sources is reconfigured, based on the computing.

A block diagram for distributed control and management of photovoltaic (PV) panels is shown. The block diagram 300 can include a plurality of power sources. The plurality of power sources can include photovoltaic solar panels such as PV panels 310, 312, 314, and 316. While four PV panels are shown, other numbers of PV panels can be included. The number of PV panels within the plurality of PV panels can be based on a target voltage or current, a reliability parameter, and so on. The solar panels can include new panels, used panels, salvaged or repurposed panels, and so on. The PV panels can include substantially similar panels in terms of size, voltage or current output, etc., or can include a diversity of PV panels. The one or more PV panels can be configured using a series connection. The series connection can be used to configure the solar panels to attain a required or target voltage, current, shape factor, volume, and the like. The block diagram 300 can include one or more distributed controller-switches such as distributed controller-switch 320. A distributed controller-switch can be coupled to each DC power source (e.g., a PV panel) within the plurality of DC power sources.

Each distributed controller-switch can include one or more components. In embodiments, the distributed controller-switch can include a bypass switch, a series switch, one or more sensors, and a communications module coupled to the system controller. The system controller can send commands, instructions, operations, etc., to each distributed controller-switch and can monitor each distributed controller-switch. The bypass switch can be used to shunt around, or bypass, the DC power source with which it is connected. The DC power source can be bypassed due to routine maintenance, series connection reconfiguration, DC power source failure, source replacement, and the like. The series switch can optionally include a pair of switches (not shown) coupled to terminals associated with the DC power source. The switches can comprise insulated-gate bipolar transistor (IGBT) switches. The terminals can include an anode terminal and a cathode terminal, connectors associated with the power source, etc. The one or more sensors can include voltage and current sensors, resistivity sensors for short circuit or open circuit detection, thermal sensors for over-temperature detection, damage or leakage sensors, and so on. The communications module can enable communications between the one or more distributed controller-switches and the system controller (further discussed below). The communications can be based on communications standards associated with wired, wireless, and hybrid wired-wireless communications standards.

The block diagram 300 can include a system controller 330. The system controller can be in communication with each of the distributed controller-switches that are associated with each of the DC power sources. In embodiments, the system controller can monitor each distributed controller-switch. The monitoring can include detecting the state of the bypass switch and the series switch, collecting sensor data from one or more sensors, communicating with the communications module associated with each distributed controller-switch, and so on. The sensor data that can be collected can include voltage data and current data, short circuit or open circuit detection based on resistivity data, and the like. The sensor data can further include temperature data. The temperature data can be analyzed to determine a normal temperature, high temperature, critical temperature, etc. The sensor data can further include DC power source status data such as the DC power source present in a series connection or missing from a series connection. The sensor data can include physical shock which could occur due to a drop, tampering, or vandalism, etc. The system controller can control each distributed controller-switch by actuating the bypass switch and the series switch associated with that controller-switch.

The system controller can be coupled to a computing device. The computing device can include a smartphone, a tablet, a laptop computer, a desktop computer, a server, a remote or cloud server, and so on. The computing device can further include a purpose-built computing device for DC power management and control. In embodiments, the computing device can be used to compute an optimal DC power source configuration, based on the monitoring. The monitored sensor data can be analyzed by the computing device. The DC power source configuration can be used to configure the DC power system, to reconfigure the DC power system, etc. The DC power source optimization can be based on one or more optimization criteria. In embodiments, the reconfiguring can enable a level voltage at output terminals of the series connection. The level voltage can include a voltage designed for power loads, a voltage for an inverter, and so on. In embodiments, the reconfiguring can enable a level current at output terminals of the series connection. The level current can be designed for power loads, the inverters, etc. In embodiments, the level voltage and/or the level current can be chosen to enable charging of various types of batteries such as nickel metal hydride (Ni-MH), lithium-ion, lithium-air, lithium iron phosphate LiFePO₄ batteries, sealed lead acid batteries, nickel-cadmium batteries, etc. In other embodiments, the reconfiguring can enable hot swapping of one or more of the plurality of DC power sources. The hot swapping can support removal and replacement of DC power sources such as PV panels without having to shut down the DC power system. In further embodiments, the computing and the reconfiguring can enable meeting a DC power source reliability metric. The reliability metric can include a voltage or current tolerance, a mean time to failure (MTTF) value, etc.

The block diagram 300 can include an inverter 340. Discussed throughout, an inverter can be coupled to the DC power system in order to convert the DC power of the power system to AC power. The AC power can include a standard voltage such as 120V or 240V, a standard frequency such as 50 Hz or 60 Hz, and so on. The inverter can invert DC power provided by the PV panels and other DC power sources. The block diagram 300 can include batteries 350. The batteries can include batteries based on various electrical energy storage technologies. The batteries can be coupled to the inverter to convert the DC power stored in the batteries to AC power. In embodiments, the batteries can be configured using a series connection, and the batteries can be controlled by distributed controller-switches. In other embodiments, the batteries can be charged by the PV panels. In the block diagram 300, the inverter can further provide AC power to one or more loads 360. The loads can include various types of lights; electrical equipment; heating, cooling, and air conditioning (HVAC) systems; water and filtration systems; and the like. In the block diagram 300, the inverter can provide AC power via reverse metering to an electrical grid such as grid 370. The grid can include a microgrid, a local grid, a regional grid, etc. The AC power provided by the inverter can be used to supplement the AC power provided by the electrical grid. The AC power provided by the inverter can be used as backup power, replacement power, etc.

Discussed previously, the plurality of DC power sources can include power sources in addition to the PV panels. In embodiments, the DC power sources can include batteries, capacitors, or other electrical energy storage components. The batteries, if present, can be configured using a series connection. The batteries can each be coupled to a distributed controller-switch, where each distributed controller-switch can be in communication with a system controller. The distributed controller-switch can include a bypass switch, a series switch, one or more sensors, and a communications module coupled to the system controller. The bypass switch and the series switch can be based on one or more solid-state switch techniques. In embodiments, the bypass switch and the series switch can comprise insulated-gate bipolar transistor switches. The series switch can further comprise a switch coupled to an anode power connection to a battery unit or a switch coupled to a cathode power connection to a battery unit. Alternatively, a series switch pair can comprise a switch coupled to an anode power connection to a battery unit and a switch coupled to a cathode power connection to a battery unit. In embodiments, the switch in the anode power connection of each battery unit and the switch in the cathode power connection of each battery unit comprise the battery unit switch pair. The battery unit switch pair can be electronically controlled by the system controller. Certain applications may benefit from implementing the series switch pair rather than a single series switch. The battery unit can include an interlock. The interlock can be based on an electromechanical lock. The lock in a locked position can indicate that the battery unit can be configured to provide power or can be bypassed using a bypass switch. The locked position can further indicate that the battery unit cannot be removed from the DC power system without initiating a removal and replacement technique. Embodiments can further include electromechanically interlocking each cell unit of the plurality of battery units as part of the configuring. The configuring can be executed by the distributed controller-switch based on instructions, commands, directions, operations, etc., received from the system controller. In embodiments, the electromechanical interlock can be controlled by the system controller. The electromechanical interlock can be based on an electrically operated locking mechanism such as a solenoid-activated locking mechanism. In embodiments, the electromechanical interlock can enable battery unit physical removal and/or replacement, or can prevent battery unit physical removal and/or replacement. In addition to enabling or preventing battery unit physical removal and/or replacement, the electromechanical interlock can enable adding a new battery unit. The adding a new battery unit can enhance energy handling capabilities of the DC power system. In other embodiments, the electromechanical interlock can prevent adding a new battery unit.

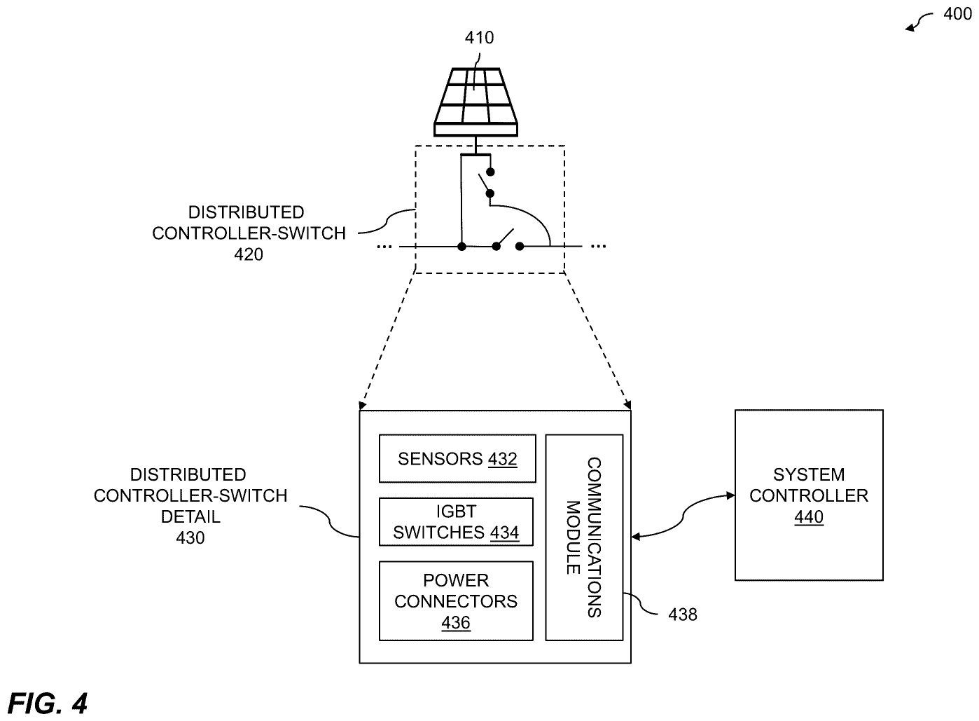

FIG. 4 is a block diagram detail of a distributed controller. Discussed previously and throughout, a distributed controller-switch can be used to bypass a connection of DC power sources. The distributed controller-switch can provide data associated with a DC power source to a system controller which can monitor the data. The system controller can determine an optimal DC power source configuration, where the optimal DC power source configuration can provide a target voltage or current, can meet DC power system requirements for power loads and reliability, and so on. The distributed controller-switch enables a distributed power system for management and control. A plurality of DC power sources is accessed, wherein the DC power sources are configured using a series connection. The series connection is bypassed, wherein the bypassing occurs at each of the DC power sources within the plurality of DC power sources, and wherein the bypassing is performed by a distributed controller-switch. Each distributed controller-switch is monitored using a system controller. An optimal DC power source configuration is computed, based on the monitoring. The plurality of DC power sources is reconfigured, based on the computing.

The block diagram includes a photovoltaic (PV) solar panel 410. The PV panel can be one of a plurality of DC power sources for use within a DC power system. The one or more PV panels can be configured using a series connection of the panels. A distributed controller-switch 420 is coupled to the solar panel. The distributed controller-switch includes switches, sensors, a communications module, and so on. A detailed view of the distributed-controller-switch 430 is shown. The distributed controller-switch includes one or more sensors 432. The sensors can include one or more of a voltage sensor, a current sensor, a resistivity sensor, a thermal sensor, and so on. The one or more sensors can include one or more of a vibration or impact sensor, a leakage sensor, a tamper sensor, and the like. The distributed controller-switch can include a bypass switch and a series switch. The bypass switch can be used as a bypass, or shunt, to bypass the panel. The panel can require bypassing for maintenance, replacement, etc. The series switch (or switch pair, if implemented), can be used to electrically isolate or disconnect the PV panel from the series connection of PV panels. The switches can be implemented based on a variety of switch technologies, such as semiconductor technologies. In the block diagram 400, the bypass switch and the series switch can comprise insulated-gate bipolar transistor (IGBT) switches 434. The IGBT devices can be operated simply and are voltage-controlled devices.

The block diagram 400 can include power connectors 436. The power connectors can enable a PV panel to be configured with other PV panels using a series connection. The power connectors can include power connectors to the PV panel, power connectors controlled by the distributed controller-switch, and so on. The power connectors can include industry standard power connectors. In the block diagram, the distributed controller-switch can include a communications module 438. The communications module can enable communications between the distributed controller-switch and a system controller. In embodiments, the communication can be based on one or more communications techniques such as wired techniques, wireless techniques, fiber-based techniques, and so on. The wired technology can include coaxial, twisted pair, etc. The wired technology can support one or more wired communications protocols such as USB, RS-232, RS-485, and the like. The communications standards used for coupling the distributed controller-switch to the system controller can further include Ethernet™, Ethernet/IP™, and EtherCAT™; fiber distributed data interface (FDDI), fiber channel, asynchronous transfer mode (ATM), etc. The communication techniques can include, 802.11, Zigbee™, near-field communication (NFC), and so on. The communications standards can further include Industrial Internet of Things (Industrial IoT, IIoT). The block diagram 400 includes a system controller 440. The system controller 440 can be used to control each distributed controller-switch in a system, such as distributed controller-switch 430. The system controller 440 can be used to manage the overall system function by configuring each distributed controller-switch to achieve a desired system outcome.

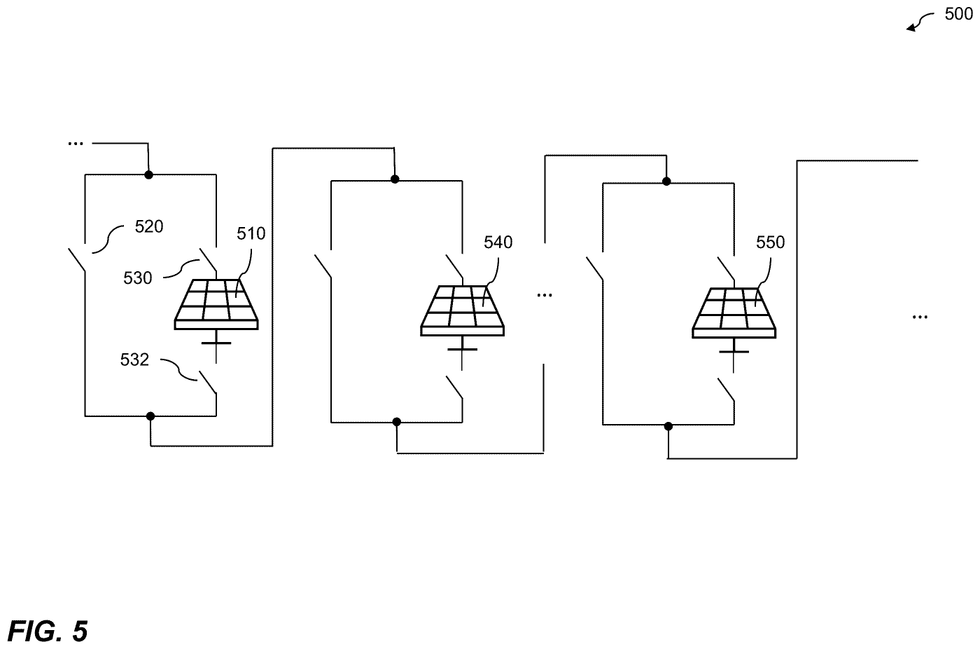

FIG. 5 is a block diagram for switching connections of photovoltaic panels. Direct current power management can be accomplished using a distributed power system for management and control. The distributed power system can access DC power sources, where the DC power sources are configured using a series connection such as shown in block diagram 500. The DC power sources can include photovoltaic (PV) solar panels. The PV panels can include new panels, repurposed panels, reclaimed panels, and so on. The PV panels can include substantially similar panels, a combination of substantially dissimilar panels, etc. The substantially dissimilar panels can differ based on power output, size, manufacturer, origin, and so on. While PV panels are shown, other DC power sources can be switched into and out of series connection configurations. The other DC power sources can include batteries such as sealed-lead-acid (SLA) batteries, lithium-iron-phosphate (LiFePO4) batteries, lithium-ion batteries, and so on. The other DC power sources can further include capacitors, supercapacitors, and other components for electrical energy storage.

A distributed controller-switch can be coupled to each PV panel such as PV panel 510. The distributed controller-switch can include a switch such as a bypass or shunt switch 520, a series switch 530, an optional additional series switch 532, one or more sensors (not shown), and a communications module (not shown). The bypass switch can be actuated by the distributed controller-switch to bypass the PV panel. The distributed controller-switch can further actuate the switch pair, switches 530 and 532. Actuating the switch pair can electrically isolate the PV panel from the series connection configuration of PV panels. The actuating the switch pair further prevents the PV panel from being short-circuited by the bypass switch. The distributed controller-switch can communicate via the communications module with a system controller. The system controller can issue commands, instructions, operations, and so on, to be executed by the distributed controller-switch. The system controller can obtain sensor data from the one or more sensors associated with the distributed controller-switch. The sensor data can include voltage, current, temperature, resistivity, and other data. The system controller can control additional PV panels such as PV panels 540 and 550. The additional PV panels can be controlled by distributed controller-switches associated with each of the additional PV panels.

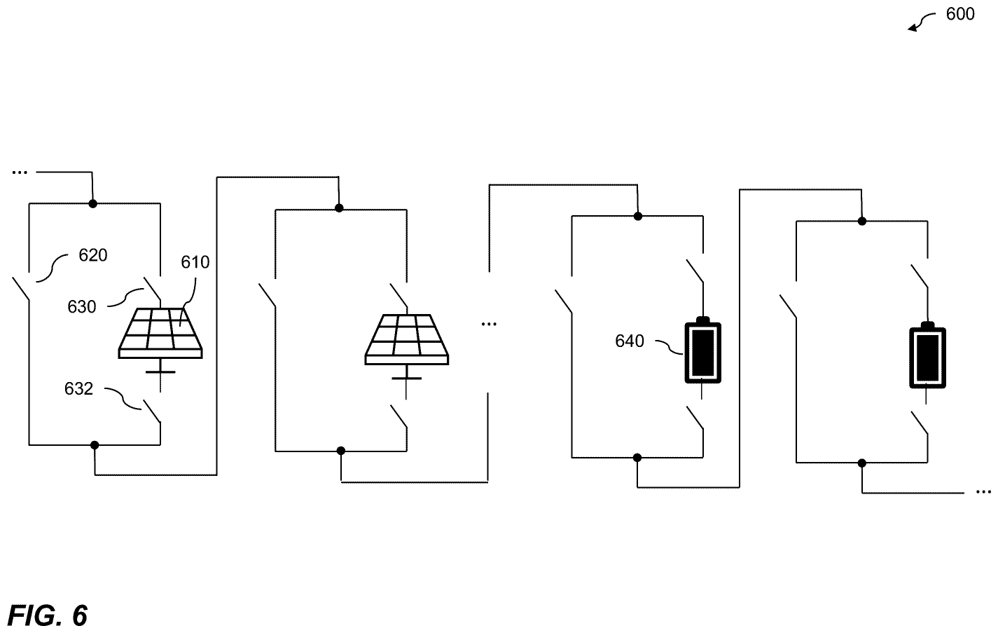

FIG. 6 is a block diagram for switching connections of photovoltaic panels and batteries in one string. Described previously and throughout, DC power systems that include power sources such as photovoltaic (PV) solar panels, batteries based on a variety of electrical energy storage technologies, capacitors such as super capacitors, and so on can be configured. Previously, the configurations included series connections of solar panels and series connections of batteries. In embodiments such as 600, the solar panels and the batteries can be configured in a single string of DC power sources. The switching connections of PV panels and batteries in one string enables a distributed power system for management and control.

The block diagram 600 can include a PV solar panel 610. The PV solar panel can include a new panel, a repurposed panel, and so on. The PV panel can be chosen based on its size, power output, origin, manufacturer, and so on. Recall that each DC power source, such as the PV panel, can include a distributed controller-switch. The distributed controller-switch can include a bypass or shunt switch 620, a series switch 630, and an optional additional series switch 632, each coupled to a series leg of the PV panel power terminals, and a communications module (not shown). A plurality of PV panels can be included in the one string of DC power sources. The block diagram can further include a battery 640. The battery can be selected for the DC power system based on various physical parameters such as size, voltage, charge capacity, etc. The battery is also coupled to a distributed controller-switch. A plurality of batteries can be included in the one string of the DC power sources. A system controller can select or deselect one or more PV panels and one or more batteries in the single string of DC power sources. The selections of PV panels and batteries can be made based on power output, storage capacity, reliability factors, etc. While clusters of single types of DC power sources are shown, in embodiments, the DC power sources can be interspersed, with one or more batteries connected in series between one or more PV panels.

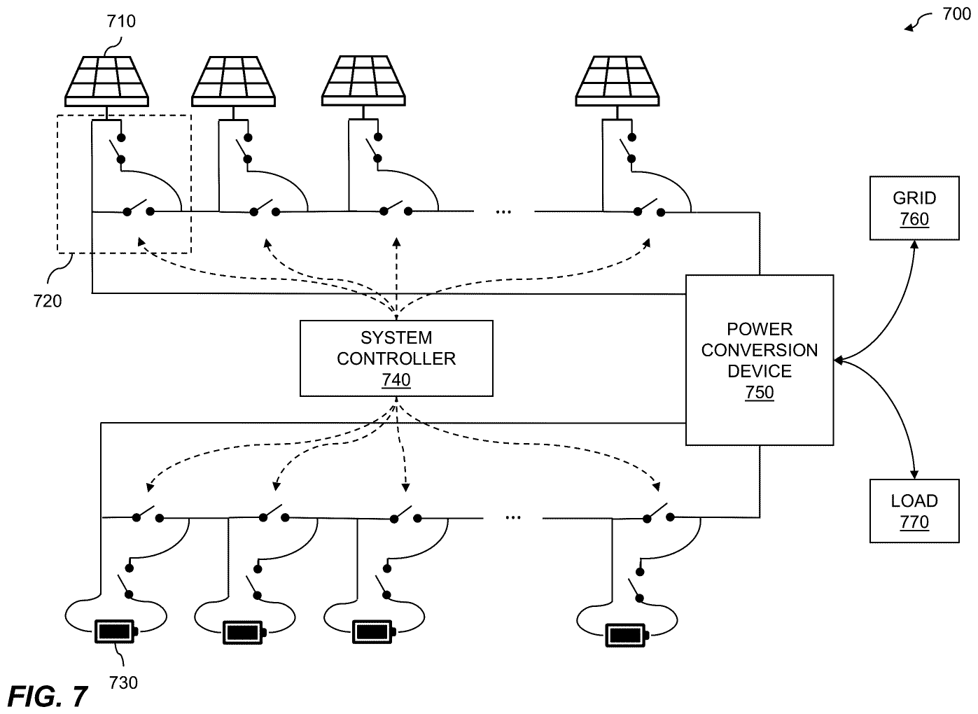

FIG. 7 is a block diagram for a distributed control and management system for direct current (DC) systems. Discussed previously and throughout, a distributed power system can be based on direct current (DC) power management. The distributed power system can include a plurality of power sources, where the power sources can include photovoltaic (PV) solar panels, batteries, and so on. Connections of solar panels and connections of batteries can be used independently or together to provide DC power. The DC power can be converted to alternating current (AC) power using one or more inverters. The one or more inverters can provide power to AC loads, power back into an electrical grid, and so on. DC power management enables a distributed power system for management and control. A plurality of DC power sources is accessed, wherein the DC power sources are configured using a series connection. The series connection is bypassed, wherein the bypassing occurs at each of the DC power sources within the plurality of DC power sources, and wherein the bypassing is performed by a distributed controller-switch. Each distributed controller-switch is monitored using a system controller. An optimal DC power source configuration is computed, based on the monitoring. The plurality of DC power sources is reconfigured, based on the computing. The optimal DC power source configuration that is computed can be based on load requirements, grid requirements, regulatory requirements, service level agreement (SLA) requirements, configuration requirements, system profile requirements, system reliability requirements, and so on.

The block diagram 700 can include one or more power sources 710, such as photovoltaic solar panels. The solar panels can include new panels, salvaged or repurposed panels, and so on. The solar panels can include substantially similar panels or can include a diversity of solar panels. The one or more solar panels can be configured using a series connection. The series connection can be used to configure the solar panels to attain a required or target voltage, current, shape factor, and the like. The block diagram 700 can include one or more distributed controller-switches 720. A distributed controller-switch can include a variety of components. In embodiments, the distributed controller-switch can include a bypass switch, a series switch (with or without a second series switch to create a switch pair, not shown), one or more sensors, and a communications module coupled to the system controller. The switch can include a shunt, or bypass, switch that can be used to bypass a DC power source. The DC power source can be bypassed due to source failure, routine maintenance, source replacement, and the like. The switch pair can include a pair of switches coupled to terminals associated with the DC power source. The terminals can include an anode terminal and a cathode terminal, connectors associated with the power source, etc. The one or more sensors can include voltage and current sensors, resistivity sensors for short circuit or open circuit detection, thermal sensors, damage or leakage sensors, and so on. The communications module can enable communications between the one or more distributed controller-switches and a system controller (discussed below). The communications can be based on communications standards associated with wired, wireless, and hybrid wired-wireless communications standards. The one or more power sources 710 and the one or more distributed controller-switches 720 can be controlled by a system controller (discussed below) and can comprise a solar management system (SMS).

The block diagram 700 can include one or more additional power sources 730. The additional power sources can include batteries, as shown, capacitors, and other electrical energy storage components. The additional power sources can be configured using a series connection. Each of the additional power sources can be coupled to a distributed controller switch. The additional one or more distributed controller-switches can be substantially similar to the distributed controller-switches described previously. In embodiments, the additional power sources and the power sources can be configured using a parallel connection. That is, the series connection of solar panels and the series connection of batteries or other DC power sources can be configured in parallel. In other embodiments, the additional power source and the power sources can be configured using a series connection. Each DC power source, such as power sources 710 and 730 can be comprised of a string of DC power sources, typically connected in series. The string of DC power sources can comprise homogeneous power sources or heterogeneous power sources. The one or more additional power sources 730 and their coupled distributed controller-switches can be controlled by a system controller (discussed below) and can comprise a battery management system (BMS). The SMS and the BMS can be controlled by the same controller and thus form an integrated SMS-BMS system.

The block diagram 700 can include a system controller 740. The system controller can be coupled to each of the distributed controller-switches associated with the DC power sources such as solar panels, and each of the distributed controller-switches associated with the additional DC power sources such as the batteries. The system controller can control each distributed controller-switch by actuating the bypass switch and the series switch. In embodiments, the system controller can monitor each distributed controller-switch. The monitoring can include detecting the state of the bypass switch and the series switch, collecting sensor data, communicating with the communications module, and so on. The sensor data that can be collected can include resistivity data which can be analyzed to detect low resistance, such as a short circuit, and high resistance, such as an open circuit. The sensor data can include temperature data. The temperature data can be analyzed to determine a normal temperature, high temperature, or critical temperature. The sensor data can further include battery status data such as present or missing, physical shock which could occur due to a drop, tampering, or vandalism, etc. The sensor data can include power source voltage and current, among other sensor data categories.

The system controller can be coupled to a computing device. The computing device can include a smartphone, tablet, laptop computer, desktop computer, server, remote server, and so on. The computing device can include a purpose-built computing device for DC power management and control. In embodiments, the computing device can be used to compute an optimal DC power source configuration, based on the monitoring. The DC power source configuration can be used to configure the DC power system, reconfigure the DC power system, etc. The DC power source optimization can be based on a variety of criteria. In embodiments, the reconfiguring can enable a level voltage at output terminals of the series connection. The level voltage can include a voltage designed for power loads, a voltage for an inverter, and so on. In embodiments, the reconfiguring can enable a level current at output terminals of the series connection. As for the voltage, the level current can be designed for loads, the inverters, and the like. In embodiments, the level current can be chosen to enable charging of various types of batteries. In other embodiments, the reconfiguring can enable hot swapping of one or more of the plurality of DC power sources. The hot swapping can support removal and replacement of DC power sources such as PV solar panels, batteries, capacitors, etc. without having to shut down the DC power system. In further embodiments, the computing and the reconfiguring can enable meeting a DC power source reliability metric. The reliability metric can include a voltage or current tolerance, a mean time to failure (MTTF) value, etc.

The block diagram 700 can include a power conversion device 750. The power conversion device 750 can convert DC power from the DC power sources to another DC voltage/current point (DC-to-DC converter) or to an AC voltage/current point (DC-to-AC inverter). An inverter can be coupled to the DC power system in order to convert the DC power to AC power. The AC power can include a standard voltage such as 120V or 240V, a standard frequency such as 60 Hz, and so on. An inverter can invert DC power provided by the PV solar panels, the batteries, and other DC power sources. The power conversion device can provide AC and/or DC power via reverse metering to an electrical grid such as grid 760. The grid can include a microgrid, a local grid, a regional grid, etc. The power conversion device can further provide AC and/or DC power to one or more loads 770. The loads can include various types of lights; electrical equipment; heating, cooling, and air conditioning (HVAC) systems; water and filtration systems; and the like. The AC power provided by the inverter can be used to supplement the AC power provided by the electrical grid. The AC power provided by the inverter can be used as backup power, replacement power, etc.

In embodiments, a system controller can manage controlled replacement of DC power sources such as photovoltaic (PC) solar panels, batteries, and so on. The system controller can be used to control a DC power system. The DC power system can comprise a plurality of PV solar panels, batteries, capacitors, and the like. The DC power system can access distributed controller-switches, where a distributed controller-switch is coupled to each DC power source. The distributed controller-switch can include a bypass switch, a series switch (or switch pair), one or more sensors, and a communications module coupled to the system controller. The distributed controller-switch associated with each DC power source can monitor sensors associated with the power source; send messages to the system controller; respond to commands, requests, etc. sent by the system controller; and so on. The distributed controller-switch can sense DC power source performance characteristics. The distributed controller-switch can process integrated button presses, actuate an electro-mechanical interlock component, etc., under control of the system controller. The distributed controller-switch can communicate an event to the system controller, such as a button press event, using a signal communication path accessible via the communications module. The button press event can indicate DC power source to be replaced. The signal communication path can be based on one or more communications standards, protocols, etc. The system controller can communicate with devices, systems, and so on beyond the DC power system. In embodiments, the communications beyond the DC power system can be enabled by an Industrial Internet of Things (IIoT) protocol. A management system can determine the DC power system configuration based on power requests to the system. The requests can be made by a user or automatically by a system requiring energy coupled to the DC power system. The management system can configure the DC power system by determining how to direct the switches such as software-controlled switches to couple specific DC power sources to achieve the desired configuration. The management system can further provide DC power system status information using protocols such as secure TCP/IP protocols.

The system controller can effect in situ DC power source configuration, reconfiguration, and so on. In embodiments, the in situ DC power source reconfiguration can enable real-time power capability adjustment for the plurality of DC power sources. The real-time power capability adjustment can be based on periodic sampling of DC power system capability, load requirements, and so on. In embodiments, the real-time power capability adjustment can provide matching between DC power source performance and DC power management system load requirements. The system controller can control adding a DC power source to a DC power system, removing a DC power source, replacing a DC power source, etc. In embodiments, the system controller can enable a DC power source hot swap operation. The system controller can further operate physical retainment of DC power sources associated with a DC power system. Further embodiments can include electromechanically interlocking each DC power source of the plurality of DC power sources as part of the configuring. The electromechanical interlock is controlled by the system controller.

The system controller can communicate with a communications device. The communications device can be remote from the system controller and can be employed by a user to communicate with the DC power system. The communications device can comprise a computer, laptop, tablet, cellphone, PDA, and the like. In embodiments, the communications device is another DC power system, power grid, charging station, etc. which can negotiate power requirements directly with the DC power system. Communication between the communications device and the system controller can be accomplished using a variety of electronic communications techniques. The communication can be accomplished over an industrial grade hardware interface such as CAN, RS485, Modbus, etc. In embodiments, the system controller enables an Industrial Internet of Things (IIoT) capability for the DC power system to enable business-to-business communications over the Internet.

Other communications protocols can be supported. The system can support protocols such as Simple Object Access Protocol (SOAP), Representational State Transfer (REST), and so on. The system controller can support queries from the communications device to the DC power system. For example, the system controller can support a query to supply system information. The system information can include DC power source profiles; system status; temperature, current, voltage, and power cycle information; and so on. The system controller can provide information based on a query of capabilities of the DC power system. The capabilities can include features, number, and health of DC power sources; voltage output range; power capacity of the DC power system; total energy; carbon footprint calculation; and so on. The system controller can also provide information based on a query on availability of output from the DC power system. An availability of output query can include information on the readiness of the system, charging time required, time until a charge is needed, and so on. In cases where one of the DC power sources in the DC power system fails, has degraded performance characteristics, represents a safety risk, etc., the system controller can decommission a DC power source. The decommissioning can disable one or more DC power sources in the system. The system controller can include the ability for a user or system to provide power request parameters to the DC power system. The power request parameters can include voltage, power, total energy, external system operating requirements, internal system operating requirements, user settings, or user preferences.

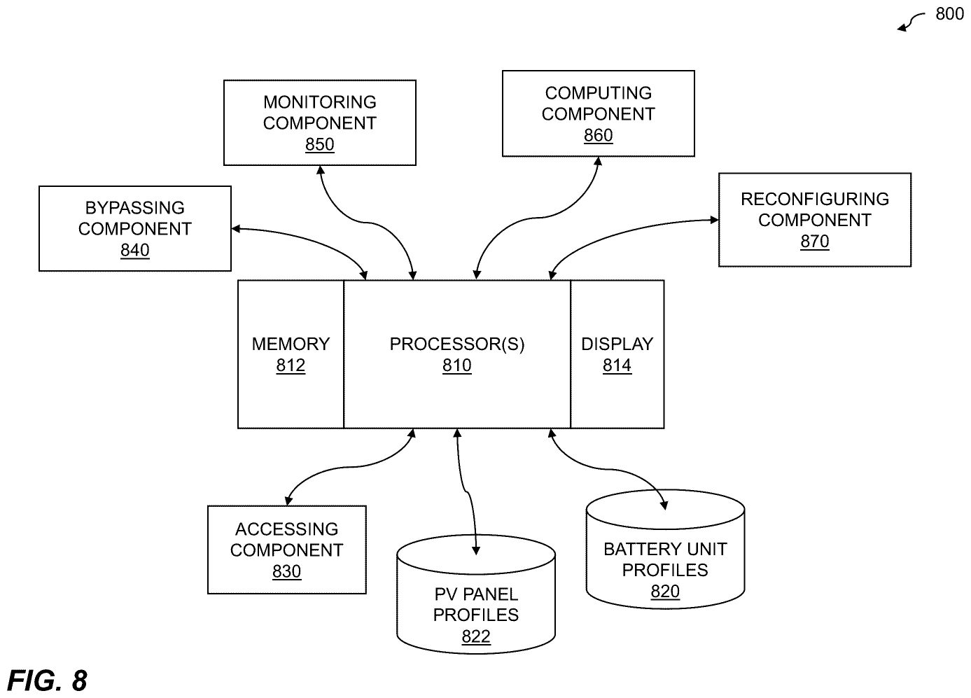

FIG. 8 is a system diagram for a direct current (DC) power management system. The direct current power management is enabled by a distributed power system for management and control. The system 800 can include one or more processors 810, which are coupled to a memory 812 which stores instructions. The system 800 can further include a display 814 coupled to the one or more processors 810 for displaying data, intermediate steps, battery unit configurations, photovoltaic unit configurations, performance information, usability and capacity data, battery and photovoltaic state, predicted capacity metrics, remaining energy, and so on. In embodiments, one or more processors 810 are coupled to the memory 812, wherein the one or more processors, when executing the instructions which are stored, are configured to: access a plurality of DC power sources, wherein the DC power sources are configured using a series connection; bypass the series connection, wherein the bypassing occurs at each of the DC power sources within the plurality of DC power sources, and wherein the bypassing is performed by a distributed controller-switch; monitor each distributed controller-switch using a system controller; compute an optimal DC power source configuration, based on the monitoring; and reconfigure the plurality of DC power sources, based on the computing.

The system 800 can include battery unit profile information 820. The battery unit profile information 820 can include data associated with batteries that can form battery units, which can in turn form the battery system. The battery unit information can include physical parameters associated with the batteries, such as size, shape, weight, terminal configuration, battery chemical type, and so on. The battery unit information can include battery unit manufacturer information, usage hours, battery unit temperature, and the like. The system 800 can include photovoltaic (PV) solar panel profile information 822. The PV panel profile information can include substantially similar information to the battery unit information such as size, shape, weight, terminal configuration, etc. The PV panel profile information can further include PV panel capacity, output voltage and current, etc. The PV panel profile information can include metadata such as manufacturer information and manufacture data, source, age, usage statistics, etc. The PV panel profile information can also include one or more inverter compatibility profiles. Profile information can be associated with further components that can be used with a DC power source. In embodiments, the profile information can include capacitor profile information. The capacitor profile information can include capacitor type such as electrolytic capacitor or supercapacitor; capacitor storage parameters such as operating voltage, temperature, and capacity in farads; etc.

The system 800 can include an accessing component 830. The accessing component can access a plurality of DC power sources. The DC power sources are configured using a series connection. The sources can further be configured using a parallel connection, a parallel-series connection, and so on. A variety of DC power sources can be accessed. In embodiments, the plurality of DC power sources can include a solar panel array. The solar panel array can include two or more photovoltaic panels, where the PV panels can be configured in a series connection, a parallel connection, a serial-parallel connection, etc. The PV panels can be substantially similar in size, current and/or voltage capacity, and so on. The PV panels can include a combination of panels from different manufacturers, panels of different ages, etc. Further embodiments can comprise including additional DC power sources in the series connection. In other embodiments, the additional DC power sources can include one or more battery units. The one or more battery units can include one or more individual battery units, one or more collections of battery units in one or more battery units, and so on. In embodiments, the one or more battery units can function as an energy source. In a usage example, a power system can include PV solar panels and batteries. The PV panels can charge the batteries while there is sufficient light to provide power and to charge batteries. In embodiments, the one or more battery units can function as an energy load. Further, the batteries can provide power during periods of low light. In addition to accessing PV solar panels and batteries, the accessing component can access a plurality of DC power sources comprising capacitors. The capacitors can include supercapacitors.

The system 800 can include a bypassing component 840. The bypassing component can bypass the series connection. The bypassing occurs at each of the DC power sources within the plurality of DC power sources, and the bypassing is performed by a distributed controller-switch. The distributed controller-switch can comprise manually operated switches, automatic switches, smart switches, and so on. In embodiments, the distributed controller-switch can include a bypass switch, a series switch, one or more sensors, and a communications module coupled to the system controller. The bypass switch and the series switch can comprise semiconductor switches, where the semiconductor switches can include one or more semiconductor fabrication techniques. In embodiments, the bypass switch and the series switch can include a mutually exclusive switching connection. The bypass switch and the series switch can operate independently from one another to enable DC source handling, DC source bypass, etc. In other embodiments, the mutually exclusive switching connection can enable dead-zone control. Dead-zone control can enable the power system to continue to operate while one or more power sources are being enabled, disabled, bypassed, etc. In a usage example, a DC power source requires hot swapping. The dead-zone control can enable switching such that the DC power source can be bypassed and decoupled from the power system without causing an open circuit in a series connection of sources or a short circuit across the terminals of the DC power source to be replace. That is, in embodiments, the dead-zone control prevents short-circuit current flow.

The one or more sensors associated with the distributed controller-switch can include current and voltage sensors, resistance sensors such as high resistance (e.g., open circuit) and low resistance or short circuit sensors, temperature sensors, shock sensors, tamper sensors, and the like. Recall that additional DC power sources can be included in an additional series connection. The additional power sources can include PV solar panels, batteries, capacitors, etc. Embodiments include bypassing the additional series connection at each of the additional DC power sources by an additional distributed controller-switch. The additional distributed controller-switch can control and switch one or more additional series connections, series-parallel connections, and the like. A variety of techniques can be used to monitor the distributed controller-switch, one or more additional controller-switches, etc. In embodiments, each additional distributed controller-switch is monitored by the system controller.

The system 800 can include a monitoring component 850. The monitoring component can monitor each distributed controller-switch using a system controller. The system controller can be colocated with the distrusted controller-switches, coupled to a DC power system comprising DC power sources, remotely located, and so on. The system controller can be coupled to each distributed controller-switch using one or more communication techniques. In embodiments, the coupling to the system controller can be performed using wired technology. The wired technology can include coaxial, twisted pair, etc. The wired technology can support one or more wired communications protocols such as USB, RS-232, RS-485, Ethernet™, and the like. In embodiments, one or more sensors enable the monitoring. In other embodiments, the coupling to the system controller can be performed using wireless technology. The wireless technology can be based on one or more wireless protocols such as Wi-Fi™, Bluetooth™, Zigbee™, near-field communication (NFC™), etc. Discussed previously, the sensors can include voltage and/or current sensors, resistivity sensors, temperature sensors, etc. The monitoring can include monitoring voltage and/or current stability, DC source overheating, etc. In embodiments, each additional distributed controller-switch can be monitored by the system controller. The additional distributed controller-switches can be monitored by the system controller using wired, wireless, or hybrid wired-wireless techniques.

The system 800 can include a computing component 860. The computing component can compute an optimal DC power source configuration, based on the monitoring. The computing device can be colocated with a DC power system, coupled to the power system, remote from the power system, and so on. The computing device can include a handheld computing device such as a smartphone, a tablet, a device purpose-built for the DC power system; a laptop computer; a desktop computer; one or more servers; and the like. The computing device can be used to configure the DC power source on site, remotely, etc. The computing device can configure the DC power source based on a target voltage and/or current, a contracted power level, and the like. The optimizing can be based on the monitoring, the battery unit profiles, the PV solar panel profiles, capacitor profiles, and so on. The optimal DC power source configuration can be accomplished by connecting DC power sources, disconnecting DC power sources, adding or replacing DC power sources, and so on. The DC power sources can include battery units, PV solar panels, capacitors, etc.

The system 800 can include a reconfiguring component 870. The reconfiguring component can reconfigure the plurality of DC power sources, based on the computing. The reconfiguring can be based on a compute objective function, contractual requirements, and the like. The reconfiguring can enable one or more DC power system requirements. In embodiments, the reconfiguring can enable a level voltage at output terminals of the series connection. The level voltage at the output terminals can be used to operate electrical equipment, to charge batteries or capacitors, etc. The level voltage at the output terminals can match voltage requirements of an inverter. The inverter can be used to convert DC power from the DC power source into an alternating current (AC) power source. In embodiments, power from the series connection and power from the additional series connection can both supply a common inverter in series. Other power topologies can also be used to provide power. In embodiments, power from the series connection and power from the additional series connection can both supply a common inverter in parallel.

In other embodiments, the reconfiguring can enable a level current at output terminals of the series connection. The level current can be used to provide an amount of current to one or more electrical loads. The level current can be used to charge batteries or capacitors. In other embodiments, the reconfiguring can enable hot swapping of one or more of the plurality of DC power sources. The hot swapping of one or more DC power sources can include hot swapping one or more batteries, one or more PV solar panels, one or more capacitors, etc. The hot swapping can enable the DC power system to continue operation during the hot swapping. In further embodiments, the computing and the reconfiguring can enable meeting a DC power source reliability metric. A DC power source reliability metric can include a percentage deviation from a target voltage or current, an uptime requirement, a mean time to failure (MTTF) value, and the like.

Over time, PV solar panels, battery units, and capacitors can lose their capacities to store energy and to deliver energy, can fail, can become combustion risks, and so on. In addition to connecting and disconnecting DC power sources using the distributed controller-switch, the reconfiguring can include adding DC power sources, replacing DC power sources, removing DC power sources, and so on. In a usage example, a DC power source can be identified by the system controller to require replacement. The replacement determination can be based on DC power source temperature, resistivity, leakage, damage, and the like. In embodiments, a to-be-replaced DC power source, from the plurality of DC power sources, can be controlled such that the series switch within the distributed controller-switch associated with the to-be-replaced DC power source can be opened, and the shunt, or bypass, switch of the to-be-replaced DC power source can be closed. The opening of the series switch and the closing of the bypass switch can be accomplished by the system controller. Further embodiments can include reconfiguring the plurality of DC power sources to remove the to-be-replaced DC power source. The reconfiguring can include substituting a spare or backup DC power source for the to-be-replaced DC power source during replacement. Further embodiments can include additionally reconfiguring the plurality of DC power sources to add a new DC power source. The new DC power source can be a substitute DC power source, a temporary replacement, a replacement, etc. In embodiments, the DC power source can be controlled such that the series switch of the DC power source is closed, and the bypass switch of the new DC power source is opened.

Discussed previously, a DC power source can require replacement. The replacement can be necessitated by the DC power source such as a PV solar panel being unable to provide sufficient voltage or current, the battery or capacitor being unable to hold charge or provide power, physical damage, combustion risk, and so on. Replacement of the DC power source can be managed by the system controller. In embodiments, a system controller replacement sequence can be initiated by a manual action on a DC power source to be replaced. The manual action can be based on identifying and selecting the DC power source to be replaced. In embodiments, the manual action can include pressing a button integrated in the DC power source to be replaced. The manual action can include toggling or sliding a switch, rotating a knob, etc. The manual action can cause a signal, flag, message, etc. to be sent to the system controller using wired, wireless, or fiber techniques. In embodiments, the manual action can be communicated to the system controller using a signal communication path associated with the DC power source to be replaced. The system controller can control physical removal or insertion of a DC power source into the DC power system. Further embodiments can include electromechanically interlocking each DC power source of the plurality of DC power sources as part of the configuring. The removing a DC power source and replacing or adding a power source can be based on one or more removal or addition techniques. In embodiments, the signal communication path of the new DC power source can be physically engaged before the new DC power source anode or terminal power connection, and cathode or other terminal power connection are made. In embodiments, the new DC power source terminal connections can be physically enabled or prevented under control of the system controller. The enabling the terminal connections can couple the DC power source to a power bus. Disabling the terminal connections can decouple the DC power source to the power bus. The disabling the DC power source series switch can be accompanied by enabling the bypass switch associated with the DC power source to bypass the DC power source. In embodiments, the system controller can enable DC power source hot swap operation. The hot swap operation can be performed without shutting down the DC power system of which the DC power source to be hot swapped is a part.

The system 800 can include a computer program product embodied in a non-transitory computer readable medium for direct current (DC) management, the computer program product comprising code which causes one or more processors to perform operations of: accessing a plurality of DC power sources, wherein the DC power sources are configured using a series connection; bypassing the series connection, wherein the bypassing occurs at each of the DC power sources within the plurality of DC power sources, and wherein the bypassing is performed by a distributed controller-switch; monitoring each distributed controller-switch using a system controller; computing an optimal DC power source configuration, based on the monitoring; and reconfiguring the plurality of DC power sources, based on the computing.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions-generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for direct current (DC) power management comprising:
accessing a plurality of DC power sources, wherein the DC power sources are configured using a series connection;
bypassing the series connection, wherein the bypassing occurs at each of the DC power sources within the plurality of DC power sources, and wherein the bypassing is performed by a distributed controller-switch;
monitoring each distributed controller-switch using a system controller;
computing an optimal DC power source configuration, based on the monitoring; and
reconfiguring the plurality of DC power sources, based on the computing.

2. The method of claim 1 wherein the distributed controller-switch comprises a bypass switch, a series switch, one or more sensors, and a communications module coupled to the system controller.

3. The method of claim 2 wherein the bypass switch and the series switch comprise a mutually exclusive switching connection.

4. The method of claim 3 wherein the mutually exclusive switching connection enables dead-zone control.

5. The method of claim 4 wherein the dead-zone control prevents short-circuit current flow.

6. The method of claim 2 wherein the bypass switch and the series switch comprise insulated-gate bipolar transistor switches.

7. The method of claim 2 wherein the coupling to the system controller is performed using wired technology.

8. The method of claim 2 wherein the coupling to the system controller is performed using wireless technology.

9. The method of claim 2 wherein the one or more sensors enable the monitoring.

10. The method of claim 1 wherein the plurality of DC power sources comprises a solar panel array.

11. The method of claim 10 further comprising including additional DC power sources in the series connection.

12. The method of claim 11 further comprising bypassing the series connection at each of the additional DC power sources by an additional distributed controller-switch.

13. The method of claim 11 wherein the additional DC power sources comprise one or more battery units.

14. The method of claim 13 wherein the one or more battery units function as an energy source.

15. The method of claim 13 wherein the one or more battery units function as an energy load.

16. The method of claim 10 further comprising including additional DC power sources in an additional series connection.

17. The method of claim 16 further comprising bypassing the additional series connection at each of the additional DC power sources by an additional distributed controller-switch.

18. The method of claim 17 wherein each additional distributed controller-switch is monitored by the system controller.

19. The method of claim 16 wherein power from the series connection and power from the additional series connection both supply a common power conversion device in series.

20. The method of claim 16 wherein power from the series connection and power from the additional series connection both supply a common power conversion device in parallel.

21. The method of claim 1 wherein the reconfiguring enables a level voltage at output terminals of the series connection.

22. The method of claim 1 wherein the reconfiguring enables a level current at output terminals of the series connection.

23. The method of claim 1 wherein the reconfiguring enables hot swapping one or more DC power sources of the plurality of DC power sources.

24. The method of claim 1 wherein the computing and the reconfiguring enable meeting a DC power source reliability metric.

25. A computer program product embodied in a non-transitory computer readable medium for direct current (DC) power management, the computer program product comprising code which causes one or more processors to perform operations of:
accessing a plurality of DC power sources, wherein the DC power sources are configured using a series connection;
bypassing the series connection, wherein the bypassing occurs at each of the DC power sources within the plurality of DC power sources, and wherein the bypassing is performed by a distributed controller-switch;
monitoring each distributed controller-switch using a system controller;
computing an optimal DC power source configuration, based on the monitoring; and
reconfiguring the plurality of DC power sources, based on the computing.

26. A computer system for direct current (DC) power management comprising:
a memory which stores instructions;
one or more processors coupled to the memory, wherein the one or more processors, when executing the instructions which are stored, are configured to:
access a plurality of DC power sources, wherein the DC power sources are configured using a series connection;
bypass the series connection, wherein the bypassing occurs at each of the DC power sources within the plurality of DC power sources, and wherein the bypassing is performed by a distributed controller-switch;
monitor each distributed controller-switch using a system controller;
compute an optimal DC power source configuration, based on the monitoring; and
reconfigure the plurality of DC power sources, based on the computing.
